(19) United States
(12) Patent Application Publication
(10) Pub. No.: US 2022/0131964 A1
(43) Pub. Date: Apr. 28, 2022

(54) PROTECTIVE CASE FOR MOBILE DEVICE

(71) Applicant: Vinci Brands LLC, Tustin, CA (US)

(72) Inventors: Daniel Poon, Nashville, TN (US); Tony Ray Plunk, Fairview, TN (US)

(73) Assignee: Vinci Brands LLC, Tustin, CA (US)

(21) Appl. No.: 17/647,169

(22) Filed: Jan. 5, 2022

Related U.S. Application Data
(63) Continuation of application No. 16/929,097, filed on Jul. 14, 2020.
Application No. 16/929,097 is a continuation-in-part of application No. 15/068,868, filed on Mar. 14, 2016, now Pat. No. 10,709,220.
(60) Provisional application No. 62/132,002, filed on Mar. 12, 2015.

(51) Int. Cl. H04M 1/18; H04B 1/3888; A45C 11/00; H04M 1/04

(52) U.S. Cl. CPC H04M 1/185; H04B 1/3888; A45C 2011/002; H04M 1/04; A45C 2011/003; A45C 11/00

(57) ABSTRACT

A protective case for a mobile device that includes a back frame and a front cover is disclosed herein. The back frame has a rigid plastic back frame with are elastomeric material bonded to portions of the plastic frame. An elastomeric insert is positioned around a portion of the interior perimeter of the back frame to provide impact resistance. Back frame engagement members are positioned on the perimeter of the rigid plastic back frame. The front cover mates with the back frame to enclose the elastomeric insert and the device. The front cover includes a touch screen cover and a rigid plastic front frame bonded to a perimeter of the touch screen cover. Front cover engagement members extend from the rigid plastic front frame that engage the back frame engagement members to bold the front cover on the back frame and enclose the device.

### CROSS-REFERENCE TO RELATED APPLICATIONS

This application is a continuation of U.S. Patent Application Ser. No. 16/929,097, filed on Jul. 14, 2020, which is a continuation-in-part of U.S. patent application Ser. No. 15/068,868, filed on Mar. 14, 2016 and issued as U.S. Pat. No. 10,709,220 on Jul. 14, 2020, which claims the benefit of U.S. Provisional Patent Application Ser. No. 62/132,002, filed on Mar. 12, 2015, the entireties of which are hereby incorporated herein by reference.

### BACKGROUND

### Field of the Invention

The present disclosure relates to protective eases for a mobile devices.

### Description of the Related Art

Mobile electronic devices, such as smartphones, tablets, laptops, and the like, are known to sustain damage from impact, contamination as a result of the ingress of water or other fluids, and contamination from dust and other debris. Such darn may result, for example, in a cracked screen, scratches on a finished surface, lost or damaged buttons or controls, cracked or bent external body components, and/or failed or malfunctioning electrical components. Protective cases can protect mobile electronic devices from such damage and other types of damage.

There is a continuing need for protective eases for mobile devices that provide improved protection from damage caused by impact, moisture, and dust.

### SUMMARY

A protective case for a mobile electronic device is disclosed therein. In some embodiments, the protective case includes a back frame and a front cover. The back frame includes a rigid plastic back frame having an elastomeric material bonded to portions of the rigid plastic back frame. The elastomeric material bonded to portions of the rigid plastic back frame forms a series of raised bumpers around the exterior surfaces of the protective case. Back frame engagement members are positioned on the perimeter of the rigid plastic back frame.

An elastomeric insert is positioned around at least a portion of an interior perimeter of the back frame. The elastomeric insert has a plurality of compressible structures that provide impact cushioning for a mobile electronic device enclosed in the protective case. The elastomeric insert also includes flexible button cover portions that allow the controls of the mobile electronic device to be used while the mobile electronic device is enclosed within the protective case.

The front cover mates with the back frame to enclose the elastomeric insert and the mobile electronic device. The front cover includes a touch screen cover and a rigid plastic front frame bonded to the perimeter of the touch screen cover. The from cover also includes an opening in the touchscreen cover that corresponds to a location of a device control when the protective cover is installed over the device and a flexible membrane that covers the opening. Front cover engagement members extend from the rigid plastic front frame. The front cover engagement members engage the back frame engagement members on the plastic back frame to hold the front frame on the back frame and enclose the mobile electronic device. The front frame engagement members extend down from the rigid plastic front frame and are positioned around an exterior perimeter of the mobile electronic device. The front engagement members may be protrusions extending from the front cover having hooked lips. The extended portions of the front cover snap into the corresponding back frame engagement members to secure the front cover to the back frame and enclose the mobile electronic device. The front cover includes a removal tab that facilitates removal of the front cover from the back frame.

In some alternative embodiments, the front cover slides over the hack frame and over the elastomeric insert to form the protective case and enclose the mobile electronic device. In such embodiments, the front cover engagement members are extended portions positioned around the perimeter of the front cover and the back frame engagement members are overhanging portions of the back frame. The extended portions of the front cover slide under the overhanging portions of the back cover to secure the front cover to the back frame and enclose the mobile electronic device with the protective case.

Each of the foregoing and various aspects, together with those set forth in the claims and summarized above or otherwise disclosed, herein, including the figures, may be combined without limitation to claims for a device, apparatus, system, method of manufacture, and/or method of use.

### BRIEF DESCRIPTION THE DRAWINGS

The figures provided herewith are intended to illustrate but not to limit the invention. Like reference characters in the figures denote corresponding features consistently throughout similar embodiments. Each drawing is generally to scale and hence relative dimensions of the various layers and components can be determined from the drawings.

FIG. 1 is an illustration of an embodiment of the disclosed protective case in unassembled form.

FIGS. 2A-2C; are respectively back, front, and side views of the assembled protective case of FIG. 1.

FIG. 3 is an illustration of a cross section of the assembled protective case of FIG. 1.

FIG. 4 is an illustration of the engagement of a front cover and back frame of an embodiment of the disclosed protective case.

FIG. 5 is an illustration of an embodiment of an elastomeric insert having compressible structures for use in the disclosed protective case,

FIG. 6 is an illustration of an, alternate embodiment of the disclosed protective case.

FIG. 7 is an illustration of the protective case of FIG. 6 showing the front cover being inserted over the back frame and elastomeric insert.

### DETAILED DESCRIPTION OF THE ILLUSTRATED EMBODIMENTS

A protective case for a mobile electronic device is disclosed herein. In some embodiments, the protective case includes a back frame and a front cover. The back frame includes a rigid plastic back frame having an elastomeric material bonded to portions of the rigid plastic back frame. The clastomeric material bonded to portions of the rigid plastic back frame forms a series of raised bumpers around the exterior surfaces of the protective case. Back frame engagement members are positioned OTI the perimeter of the rigid plastic back frame.

An elastomeric insert is positioned around at least a portion of an interior perimeter of the back frame. The elastomeric insert has a plurality of compressible structures that provide impact cushioning for a mobile electronic device enclosed in the protective case. The elastomeric insert also includes flexible button cover portions that allow the controls of the mobile electronic device to be used while the mobile electronic device is enclosed within the protective case.

The front cover mates with the back frame to enclose the elastomeric insert and the mobile electronic device. The front cover includes a touch screen cover and a rigid plastic front frame bonded to the perimeter of the touch screen cover. The front cover also includes an opening in the touchscreen cover that corresponds to a location of a device control when the protective cover is installed over the device and a flexible membrane that covers the opening. Front cover engagement members extend from the rigid plastic front frame. The front cover engagement members engage the back frame engagement members on the plastic back frame to hold the front frame on the back frame and enclose the mobile electronic device. The front frame engagement members extend down from the rigid plastic front frame and arc positioned around an exterior perimeter of the mobile electronic device. The front engagement members may be protrusions extending from the front cover having hooked lips. The extended portions of the front cover snap into the corresponding back frame engagement members to secure the front cover to the back frame and enclose the mobile electronic device. The from cover includes a removal tab that facilitates removal of the front cover from the back frame.

In some alternative embodiments, the front cover slides over the back frame and over the elastomeric insert to form the protective case and enclose the mobile electronic device. In such embodiments, the front cover engagement members are extended portions positioned around the perimeter of the front cover and the back frame engagement members are overhanging portions of the back frame. The extended portions of the front cover slide under the overhanging portions of the back cover to secure the front cover to the back frame and enclose the mobile electronic device with the protective case,

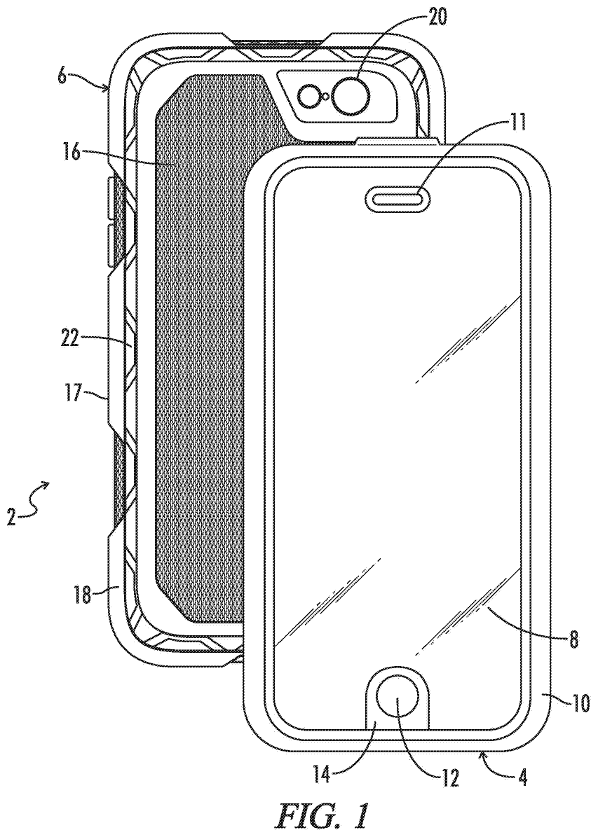

FIG. 1 illustrates an embodiment of the disclosed protective case 2 in unassembled form. The protective case has two primary pieces, a front cover 4 and a back frame 6. The front cover 4 has a touchscreen cover 8 bonded to a rigid plastic frame 10 that surrounds the perimeter of the touchscreen rover 8. The touchscreen cover 8 includes a speaker opening 11 and a button opening 12 covered by a flexible membrane 14 that allows the covered button to be operated. The back frame 6 includes a rigid plastic frame 16 with a flexible elastomeric layer 18 bonded over portions of the rigid plastic frame 16 to form cushioning bumpers 17. Preferably, the rigid plastic is a shatter resistant polycarbonate that is clad in an elastomeric, rugged, shock-absorbing silicone. A camera opening 20 is provided in the rigid back frame 6 to allow the enclosed device's camera to be used while the device is enclosed within the protective case 2. An elastomeric insert 22 is positioned inside the back frame 6 around its perimeter to provide impact cushioning for the enclosed device.

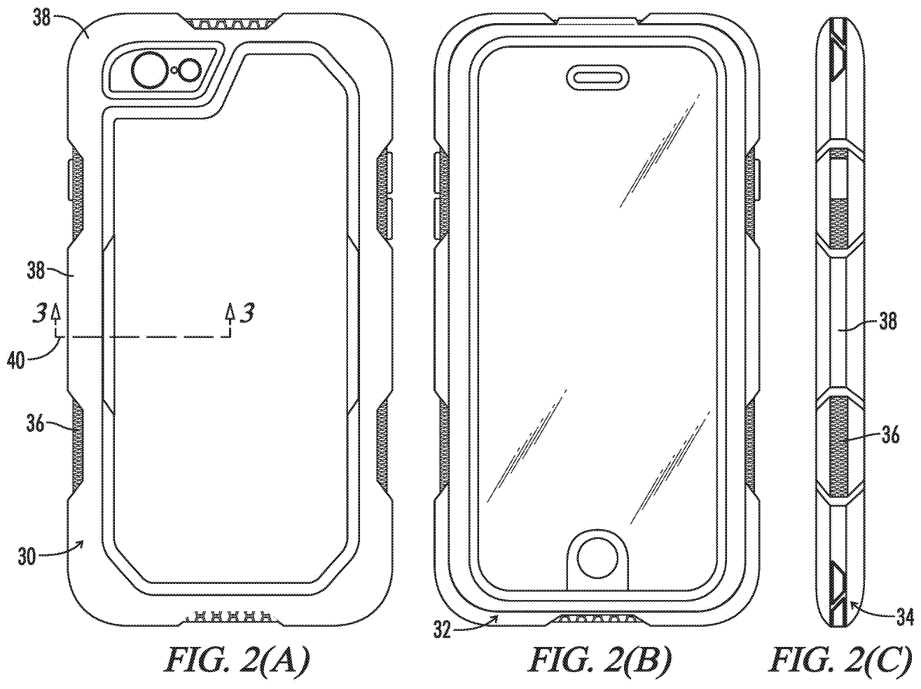

FIGS. 2A-2C illustrate hick 30, front 32, and side views 34 of the assembled protective case of FIG. 1. As discussed above, alternating patches of exposed hard plastic 36 and elastromeric material 38 are bonded Over the hard plastic 36 to form bumpers 38 around the edges of the case.

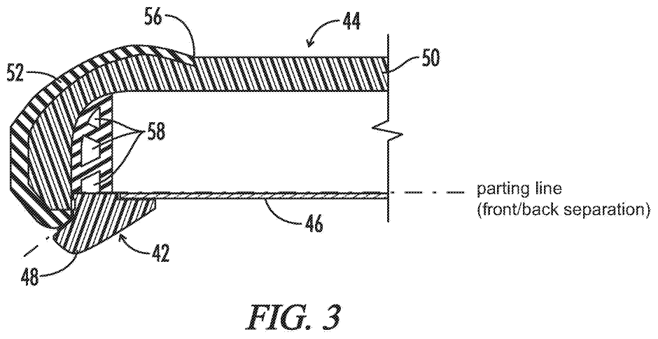

FIG. 3 illustrates a cross section of the assembled protective case of FIGS. 2A-2C. along the line 40. The front cover 42 includes the touchscreen cover 46 bonded to the hard plastic perimeter 48. The back frame 44 has a rigid plastic frame 50 and elastomeric overlaid portions 52 elastomeric insert 54 positioned in the back frame 44 has compressible cavities 58 that cushion an enclosed device from impact. Connectors such as snap connectors, discussed in more detail below, between the front cover 42 and back frame 44 compress the elastomeric insert 54 between the rigid plastic 48 of the front cover and the rigid plastic 50 of the back frame. The compression of the elastomeric insert 54 between rigid plastic of the front cover 42 and the back frame 44 creates a dust and moisture resistant seal that protects the electronic device held within the case. Grooves, cavities, and similar features 56 are provided on the hard plastic 48 of the back frame 44 to assist in securing the elastomeric portions 52 to the plastic.

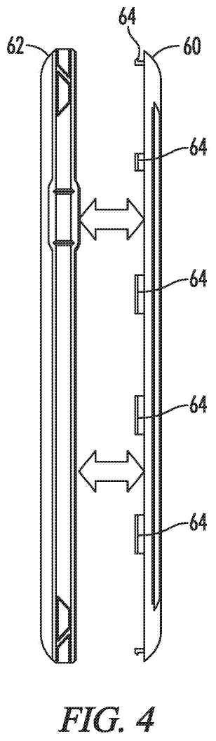

FIG. 4 illustrates the engagement of a front coyer 60 and back frame 62 of an embodiment of the disclosed protective ease. The snap connections are formed between extended protrusions 64 on the front cover 60 of the case that mate with corresponding features on the back frame 62. While snap connectors are preferred, a variety of other types of connectors well known in the art may alternatively be used.

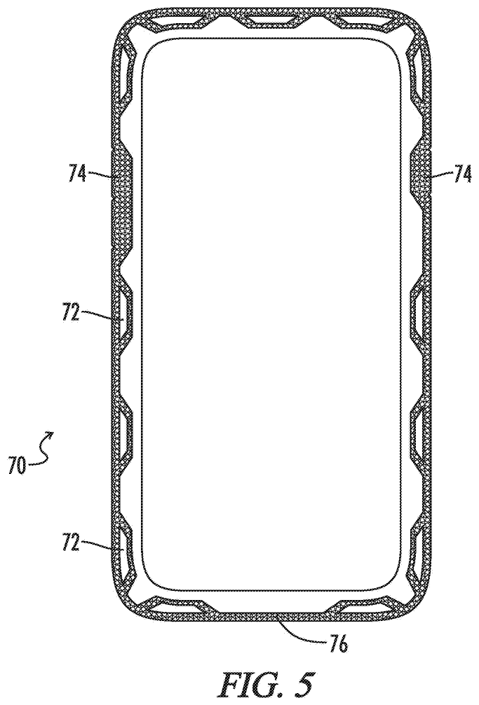

FIG. 5 illustrates an embodiment of a preferred elastomeric insert 70 having compressible structures 72 for use in the disclosed protective case. The compressible structures 72 are positioned so that they surround the perimeter of the enclosed device. The elastomeric insert 70 has button covering portions 74 that correspond to the locations of the controls of the device. These flexible button covering portions 74 allow the controls of the enclosed device to be activated while the device is enclosed within the assembled case with its perimeter surrounded by the elastomeric insert 70. Openings 76 are provided in the elastomeric insert that allow external cables to be connected to the connectors of the device while the device is enclosed in the protective case. Those skilled in the art will appreciate that the location of the button covering portions 74 and the openings 76 will depend upon the configuration of the device for which the case is designed.

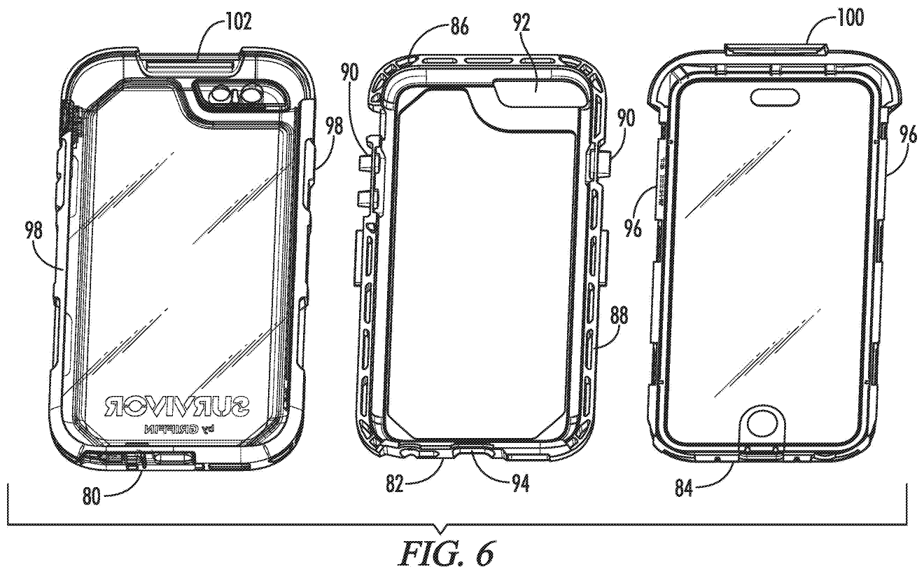

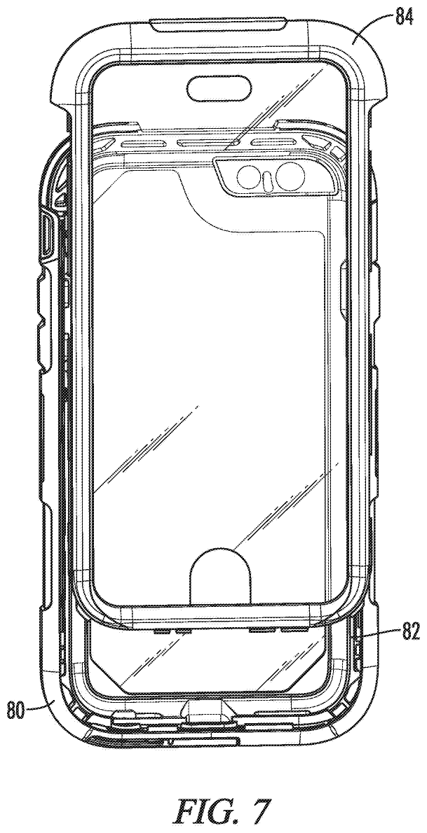

FIG. 6 illustrates an alternate embodiment of the disclosed protective ease. In the embodiment shown, the case is assembled by placing the elastomeric insert 82 in the back frame 80, and sliding the front cover 84 over the back frame 80 and elastomeric insert 82. FIG. 7 is an illustration of the protective device case of FIG. 6 showing the front cover being inserted over the back flame and elastomeric insert. The elastomeric insert 82 has compressible structures 86 and 88 that increase the impact resistance of the case. Pads 90 are provided on the insert 82 that allow the controls of an enclosed device to be operated. Openings 94 in the elastomeric insert 82 allow external cable connections to an enclosed device. In the embodiment shown, the volume and power buttons of the device are covered, and hinged plugs seal the connectors, headphone port, and hold switch.

Extended portions 96 on the perimeter of the front cover 84 slide under overhanging portions 98 of the back frame 80 to secure the front cover to the back frame and enclose the mobile electronic device within the protective case. A locking extension 100 on the top of the front cover snaps onto a corresponding portion 102 on the top of the back frame when the front cover is fully inserted into the hack frame to secure the front and back together. The locking extension 100 also functions as a finger grip that assists in the removal of the front cover from the back frame.

The previous description of the disclosed embodiments is provided to enable any person skilled in the art to make or use the invention disclosed herein. Although the various inventive aspects are disclosed in the context of certain illustrated embodiments. implementations, and examples, it should be understood by those skilled in the art that the invention extends beyond the specifically disclosed embodiments to other alternative embodiments and/or uses of the invention and obvious modifications and equivalents thereof. In addition, while a number of variations of various inventive aspects have been shown and described in detail, other modifications that are within their scope will be readily apparent to those skilled in the an based upon reviewing this disclosure. It should be also understood that the scope of this disclosure includes the various combinations or sub-combinations of the specific features and aspects of the embodiments disclosed herein, such that the various features, modes of implementation, and aspects of the disclosed subject matter may be combined with or substituted for one another. The generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein,

Similarly, the disclosure is not to be interpreted as reflecting an intent that any claim set forth below requires more features than are expressly recited in that claim. Rather, as the following claims reflect, inventive aspects may reside in, a combination of fewer than all features of any single foregoing disclosed embodiment.

Each of the, foregoing and various aspects, together with those set forth in the claims and summarized above or otherwise disclosed herein, including the figures, may be combined without limitation to form claims for a device, apparatus, system, method of manufacture, and/or method of use.

All references cited hero ire hereby expressly incorporated by reference.

What is claimed:

1. A protective case configured to reversibly receive and retain a mobile device, said protective case comprising:
a device compartment dimensioned to retentively receive the mobile device, said device compartment comprising:
opposing front face and back face walls, opposing left and right side walls, and opposing top and bottom side walls connected to and generally perpendicular to said left and aught side walk,
wherein the device compartment is defined by separable components including a back frame, as unitary elastameric insert, and a front cover;
wherein the back frame is configured to define the back face wall and a plurality of side walk, said back frame comprising:
a first rigid plastic frame defined by an outward-facing surface and an opposing inward-facing surface that defines an interior perimeter;
an outermost elastomeric material bonded to discrete portions of the outward-facing surface of the first rigid plastic frame; and
rigid plastic attachment extensions positioned on and extending from the interior perimeter of the first rigid plastic frame at opposing side walls;
wherein the unitary elastomeric insert has an outer surface and an opposing inner surface;
wherein the outer surface is positioned in contact, with the interior perimeter of the first rigid plastic frame and the inner surface is in contact with the mobile device when the device is inserted into the case;
wherein the elastomeric insert extends from the back face wall towards the attachment extensions to define a slot there-between; and
wherein the front cover is configured to slidably mate into a. closed position with the back frame to enclose the elastomeric insert and the mobile device when the device is inserted in the device compartment,
wherein the front cover is configured to define the front face wall and comprises a unitary second rigid plastic frame having perimeter protrusions dimensioned to be slidably received within the slot so that the front cover is in contact with the elastomer insert when the front cover is slidably mated to said back frame.

2. The protective case of claim 1, further including a protective cover configured to overlie the touch screen of the mobile device when the device is enclosed within the protective case, wherein the second rigid plastic frame is bonded to a perimeter of said protective cover.

3. The protective case of claim 1, wherein said unitary elastomeric insert is annular in shape.

4. The protective case of claim 1, wherein said unitary elastomeric insert comprises compressible cavities that are positioned to surround the mobile device on multiple side walls when the device is enclosed in the protective case.

5. The protective case of claim 1, wherein the outermost elastomeric material is bonded to discrete portions of the outwardly facing, surface of the first rigid plastic frame and forms a plurality of raised bumpers on the exterior of the protective case that are spaced apart from one another around the side walls of the protective case, and wherein the first rigid plastic frame is visibly revealed in the external spaces between the raised bumpers.

6. The protective case of claim 1, wherein when the front cover is slidably mated to the back frame the elastomeric insert is compressed between the front cover and the back frame to create a moisture-resistant seal.

7. The protective case of claim 1, wherein the outermost elastomeric material bonded to discrete portions of the outwardly facing surface of the rigid plastic frame forms one or more of the external surfaces of the side walls and at least a portion of the external surface of the back face wall.

8. The protective case of claim 1, wherein when the front cover is slidably mated to the back frame, the back frame and front frame together comprise one or more of the same walls.

9. The protective case of claim 1 further comprising ail external locking mechanism comprising a locking extension on the top of the front cover that is configured to snap onto a corresponding portion on the hack frame so as to lock the front cover in a mated position to the hack frame when the front cover is fully inserted into the hack frame.

10. The protective case of claim 1, wherein said elastomeric insert further comprises protruding pads that are entirely concealed within the case and configured to interface with controls of the electronic device when the device is inserted in the protective case.

11. The protective case of claim 1, wherein said elastomeric insert further comprises an opening, corresponding in position to an opening in the first rigid plastic frame, dimensioned to allow for an external connection to the device when the device is received in the protective case.
